(19) United States
(12) Patent Application Publication
(10) Pub. No.: US 2008/0186705 A1
(43) Pub. Date: Aug. 7, 2008

(54) LIGHTING UNIT STRUCTURE

(76) Inventor: Ming-Huang LIU, Taichung County (TW)

Correspondence Address: EGBERT LAW OFFICES, 412 MAIN STREET, 7TH FLOOR, HOUSTON, TX, 77002, US

(21) Appl. No.: 11/671,389

(22) Filed: Feb. 5, 2007

(51) Int. Cl. F21V 21/088

(52) U.S. Cl. 362/250

(57) ABSTRACT

The present invention provides a lighting unit, including a body and a light-emitting element. The body has a circuit component set, a switch linked to the circuit component set, and a plurality of through-hole coupling portions placed properly. The coupling portion is provided with a spacer, and the light-emitting element is composed of a seat, a light condenser and an illuminator. The light condenser and illuminator are installed onto one end of the seat, and a mounting portion is placed at the other end of the seat. The light-emitting element is installed via the mounting portion, making it possible to adjust radiation direction on the body.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a lighting unit, and more particularly to an innovative lighting unit with a convenient clipper structure.

2. Description of Related Art Including Information Disclosed Under 37 CFR 1.97 and 37 CFR 1.98

The lighting units are generally installed onto caps to overcome the inconvenience of nighttime activities when manually holding flashlights or searchlights. However, most conventional lighting units are provided with one or several light-emitting elements, which change their illumination direction only when the users turn around. So, it is impossible to flexibly adjust the direction through the body of the lighting unit, presenting disadvantages of inefficiency and inconvenience.

Thus, to overcome the aforementioned problems of the prior art, it would be an advancement in the art to provide an improved structure that can significantly improve efficacy.

To this end, the inventor has provided the present invention of practicability after deliberate design and evaluation based on years of experience in the production, development and design of related products.

### BRIEF SUMMARY OF THE INVENTION

The enhanced efficacy of the present invention is based upon a lighting unit comprised of a body 1 and a plurality of light-emitting elements 2. The light-emitting element 2 is installed via mounting portion 213 onto the coupling portion 15 of the body 1, and then locked by the snapper 216 onto the spacer 151. Since the guiding portion 215 and snapper 216 of the mounting portion 213 are arranged circularly, the bottom of snapper 216 and external flange of the guiding portion 215 rotate transversely along the spacer 151 when the snapper 216 head is locked by the spacer 151. The light-emitting element 2 can be screwed onto the body 1 and swing transversely, making it possible to adjust the illumination direction. Referring to FIG. 3, when some light-emitting elements 2 are screwed onto the body 1, the radiation direction of the light-emitting elements 2 could be adjusted. Referring to FIG. 4, these elements could also be adjusted into focusing, thus presenting improved efficiency and convenience.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the present invention.

FIG. 2 shows an assembled perspective view of the present invention.

FIG. 3 shows a perspective view of the application of the present invention.

FIG. 4 shows another perspective view of the application of the present invention.

FIG. 5 shows a perspective view of another preferred embodiment of the present invention.

FIG. 6 shows a perspective view of the application shown in FIG. 5 of the present invention.

FIG. 7 shows another perspective view of the application shown in FIG. 5 of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

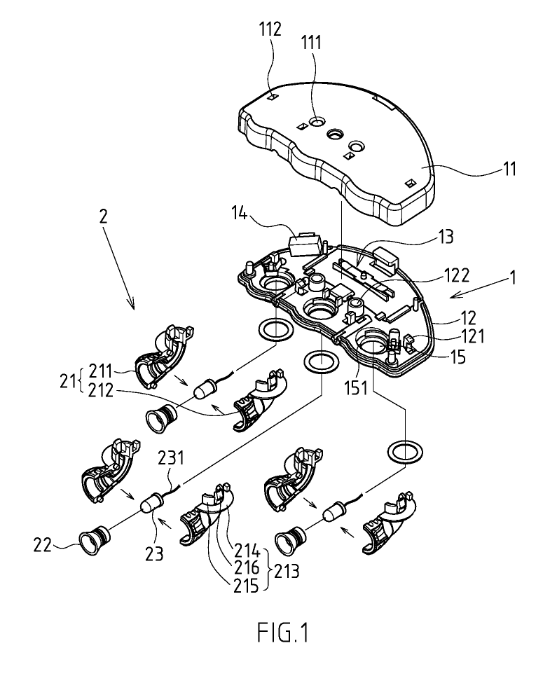

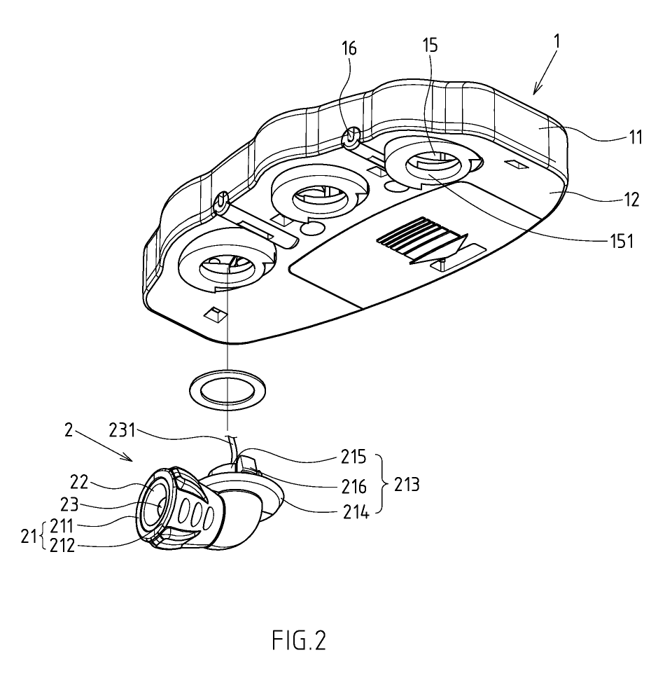

Referring to FIGS. 1 and 2, there is the lighting unit, shown in a preferred embodiment of the present invention.

The lighting unit comprises a body 1, which is assembled by upper and lower portions 11, 12. On the surface of upper portion 11, a few mounting holes 111 and locking holes 112 are arranged at intervals to fix the protruding column 121 and locking column 122 of the lower portion 12. The lower portion 12 is provided with a circuit component set 13, a switch 14 linked to the circuit component set 13 for control of power distribution, and several through-hole coupling portions 15 placed laterally and alternatively on the lower portion 12. A reducing spacer 151 is mounted onto the inner wall of the coupling portion 15.

The present invention also includes a plurality of light-emitting elements 2, each being composed of a seat 21, a light condenser 22 and an illuminator 23. The seat 21 of a hollow structure is assembled by left and right portions 211, 212, while the light condenser 22 is sleeved externally onto the illuminator 23 and fixed onto one end of seat 21 when the left and right portions 211, 212 are covered. The illuminator 23 is linked to the circuit component set 13 via electric wire 231. Moreover, the other end of the seat 21 is folded upwards, where a mounting portion 213 is placed onto the disc stopper 214 on the surface of seat 21. A guiding portion 215 and a snapper 216 are arranged opposite to each other on the stopper 214. The flexible snapper 216 has a tapered head such that the light-emitting element 2 could be installed via mounting portion 213 onto the coupling portion 15 of the body 1, and then locked by the snapper 216 head onto the spacer 151. Thus, the radiation direction of light condenser 22 and illuminator 23 runs parallel to the surface of the body 1.

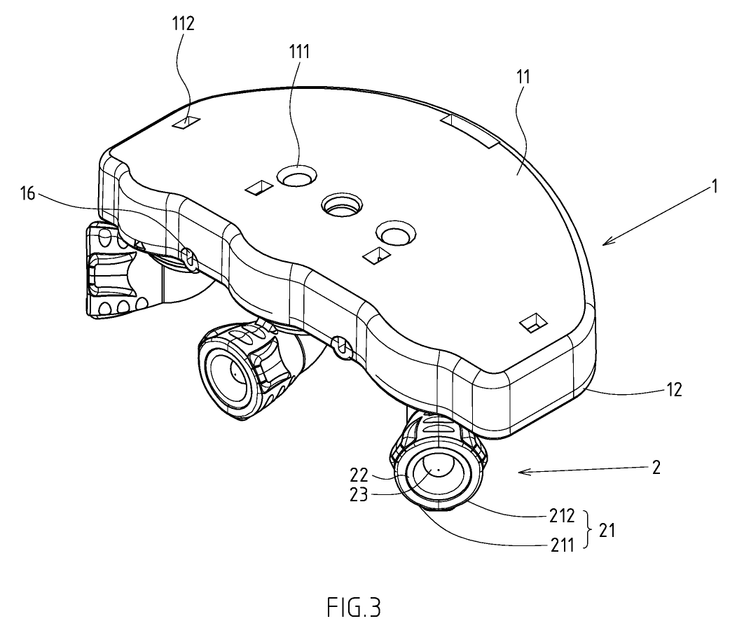

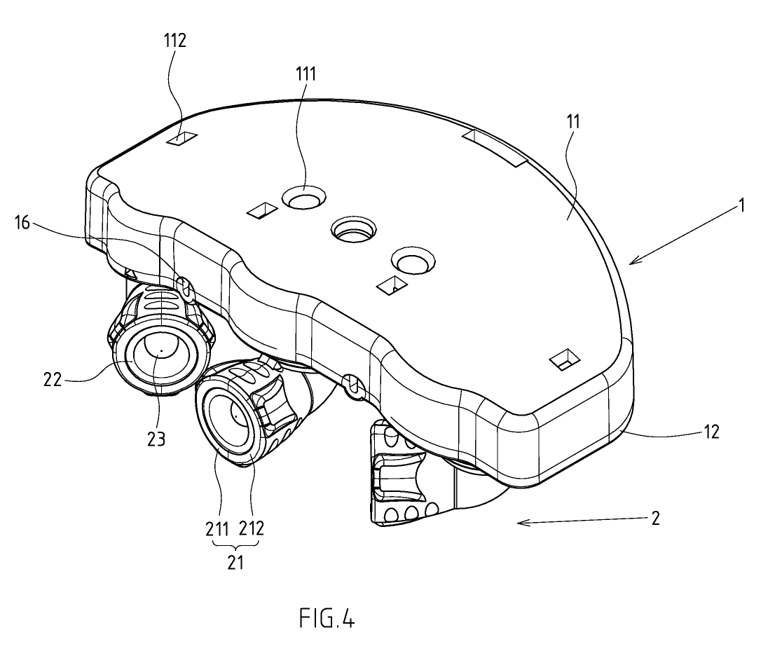

Since the guiding portion 215 and snapper 216 of the mounting portion 213 are arranged circularly, the bottom of snapper 216 and the external flange of the guiding portion 215 rotate transversely along the spacer 151, when the snapper 216 head is locked by the spacer 151. The light-emitting element 2 can be screwed onto the body 1 and swing transversely, making it possible to adjust the radiation direction. Referring to FIG. 3, when some light-emitting elements 2 are screwed onto the body 1, the radiation direction of the light-emitting elements 2 could be adjusted. Referring to FIG. 4, these elements could also be adjusted into focusing, thus presenting improved efficiency and convenience.

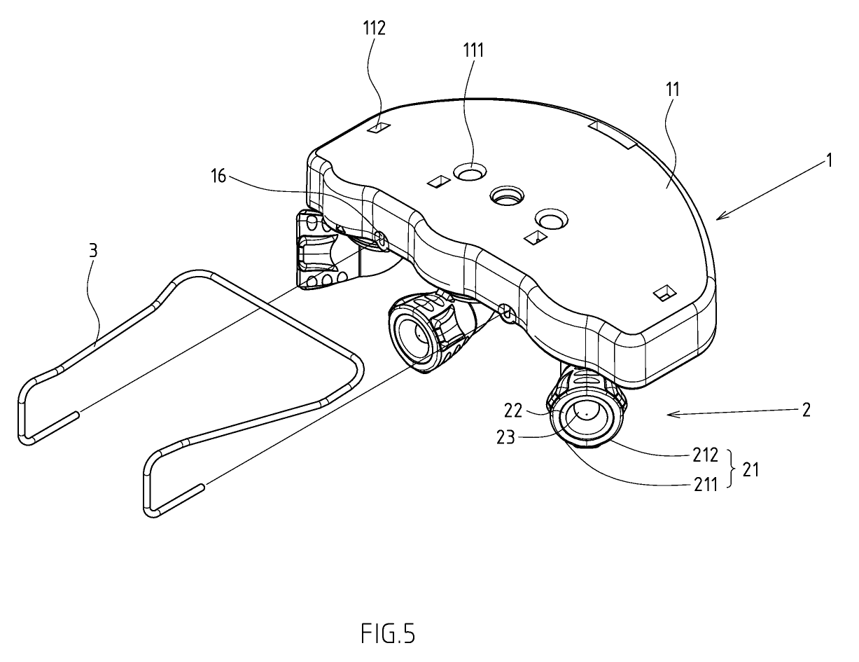

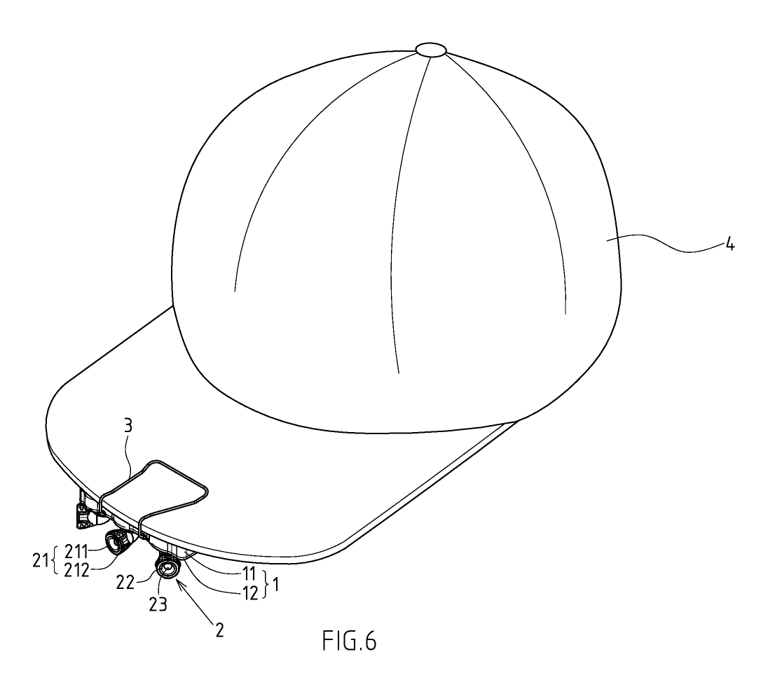

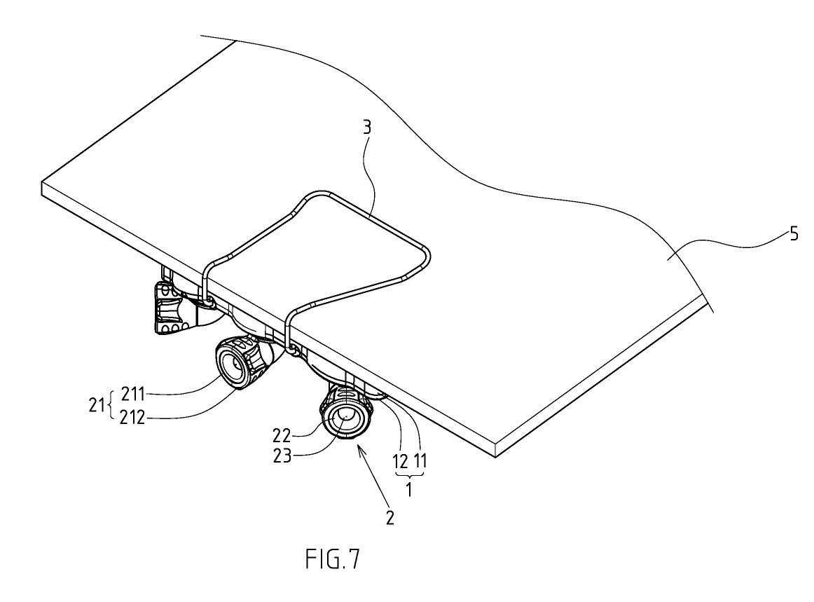

Referring to FIG. 5, two recessed holes 16 are arranged at intervals in the front of the body 1. A fixture 3 could be inserted into these two recessed holes 16 for fixation of specific objects. Referring to FIG. 6, when the body 1 is fitted with a fixture 3, it can be fastened onto a cap 4, or other plain objects 5 (shown in FIG. 7).

1-7. (canceled)

8. A lighting assembly comprising:
a body having an interior space, said body having a top surface and a bottom surface, said bottom surface having a plurality of through holes formed therein, said interior space having a circuit component set and a switch electrically connected together; and
a plurality of light-emitting elements respectively rotatably received by said plurality of through holes of said body, each of said plurality of light-emitting elements comprising:
a seat;
a light condenser affixed within said seat at one end of said seat; and
an illuminator received in said light condenser and retained in said seat, said illuminator having a wire extending through said seat and connecting with said circuit component set, said seat having a generally L-shaped configuration, said set having a mounting portion at an opposite end thereof, said mounting portion having a disc-shaped stopper in surface-to-surface contact with said bottom surface of said body, said mounting portion having a guiding portion and a snapper formed above said disc-shaped stopper, said guiding portion extending into the through hole of said body, said snapper resiliently engaging a surface of said through hole so as to selectively lock said mounting portion in the through hole, said illuminator extending in a plane parallel to said bottom surface.

9. The lighting assembly of claim 8, said body having an upper portion affixed to a lower portion.

10. The lighting assembly of claim 8, said seat having a right portion affixed to a left portion.

11. The lighting assembly of claim 8, each of said plurality of through holes having a spacer therein, said snapper being locked onto said spacer.
